(19) United States
(12) Patent Application Publication
(10) Pub. No.: US 2026/0338824 A1
(43) Pub. Date: Oct. 29, 2026

(54) SYSTEMS AND METHODS FOR DIGITAL SENSING OF SMALL CAPACITANCES

(71) Applicant: Nanusens SL, Cerdanyola del Vallès (ES)

(72) Inventors: Philip Mark DANIELL, London (GB); Josep Montanyà i Silvestre, Cerdanyola del Vallès (ES)

(73) Assignee: Nanusens SL, Cerdanyola del Vallès (ES)

(21) Appl. No.: 19/655,828

(22) Filed: Apr. 23, 2026

Related U.S. Application Data
(60) Provisional application No. 63/793,135, filed on Apr. 23, 2025.

(51) Int. Cl. G01P 15/125; G01P 15/18; G01P 15/08

(52) U.S. Cl. CPC G01P 15/125; G01P 15/18; G01P 2015/0865

(57) ABSTRACT

A MEMS-based capacitive sensor includes a first sensor having a MEMS-based differential accelerometer including first and second legs and configured to output a first frequency signal and a second frequency signal. The sensor includes a reference oscillator that outputs a reference frequency signal. A controller is arranged to receive the first frequency signal, the second frequency signal, and the reference signal, compare the received frequency signals, and output a trigger signal when a threshold value corresponding to detected motion is exceeded.

### CROSS-REFERENCE TO RELATED APPLICATIONS

This application claims priority to and the benefit of US Provisional Application No. 63/793,135, filed on Apr. 23, 2025, and entitled “SYSTEMS AND METHODS FOR DIGITAL SENSING OF SMALL CAPACITANCES,” the entire contents of which are incorporated herein by reference.

### TECHNICAL FIELD

The present disclosure relates to semiconductor devices and, more particularly, to digital sensing circuits.

### BACKGROUND

Conventional MEMS sensors use a complex and large analog chain, typically in the form of a (switched) transconductance amplifier, but other approaches are possible. MEMS in CMOS have been typically fabricated using a 180nm node. But if such MEMS devices are ported to lower geometries, the MEMS device will shrink while scaling to the lower geometries, resulting in a smaller minimum feature size of these lower CMOS nodes. Unfortunately, analog circuits do not scale well into lower geometries. Hence, there is a problem because the cost per area in the lower CMOS nodes is more expensive, resulting in the MEMS device becoming prohibitively expensive.

### SUMMARY

To address the problems associated with porting MEMS to devices having lower geometries, the present disclosure describes a digital sensing circuit for MEMS capacitances. In certain implementations, the MEMS device can function like a ring oscillator loaded with a MEMS capacitance. When the MEMS capacitance changes slightly, the exact frequency generated by the ring oscillator correspondingly changes. In various implementations, the ring oscillator drives a counter, and hence reading periodically the counter (the period may be set by another ring oscillator without a MEMS but a fixed capacitance). The frequency is determined and hence the MEMS capacitance. In order to account for deviations in the oscillator that provides the periodicity to read the counter and other factors, an implementation includes two circuits. One circuit with a fixed MEMS capacitance, which is the reference, and another circuit with the actual MEMS sensor, which provides the sensed signal.

In some implementations, a digital sensing circuit is realized (in practical terms) because the MEMS are so small, and hence their capacitance values are very small. Typically MEMS capacitances are in the order of 1pF, while the inventive MEMS disclosed herein in 180nm are in the order of 50fF or less, while going to lower CMOS nodes, the capacitances are even much smaller. Trying to use a digital sensing circuit with a conventional MEMS would be prohibitive in terms of power consumption, because it requires charging and discharging the MEMS capacitance many times.

Various implementations may include fabrication of a MEMS device via the back-end metal layers of any solid state or semiconductor process including, for example, a CMOS process. Fabrication may include, for example, compound processes, like GaAs, GaN and SiGe among others without limitation. In all these cases, etching may be performed with vHF or other techniques as post-processing vHF etching. However, etching processes other than vHF may be used for MEMS capacitive switching devices and systems disclosed herein. Also, MEMS devices may be built and/or fabricated using MEMS manufacturing processes other than vHF etching. For example, MEMS devices may be formed by building a MEMS process with a large number of structural layers and then implementing the devices. Various implementations also include MEMS devices configured to withstand electrostatic discharge (ESD).

In one aspect, a MEMS-based capacitive sensor includes a first sensor having a first MEMS-based differential accelerometer including first and second legs and configured to output a first frequency signal and a second frequency signal. The sensor also includes a reference oscillator configured to output a reference frequency signal. A controller is arranged to receive the first frequency signal, the second frequency signal, and the reference frequency signal, compare the received frequency signals, and output a trigger signal when a threshold value is exceeded that is indicative of detected motion of a device.

The MEMS capacitance of the first MEMS-based differential accelerometer may be 50fF or less. The first MEMS-based differential accelerometer may include a first sensor ring oscillator where each of the first and second legs of the first MEMS-based differential accelerometer is alternately switched into the first sensor ring oscillator multiple times during a measurement period to reduce the effects of noise. The controller may include a first sensor counter configured to generate a first counter value corresponding the first frequency signal and a second sensor counter configured to generate a second counter value corresponding to the second frequency signal over the measurement period. The first sensor may be oriented along a first axis.

The MEMS-based capacitive sensor a second sensor may include a second MEMS-based differential accelerometer having third and fourth legs configured to output a third frequency signal and a fourth frequency signal, where the second MEMS-based differential accelerometer includes a second sensor ring oscillator circuit and wherein each of the third and fourth legs of the second MEMS-based differential accelerometer are alternately switched into the second sensor ring oscillator circuit multiple times during the measurement period to reduce the effects of noise.

The capacitive sensor may function as a motion sensor for a vehicle alarm, e-Bike alarm, Internet-of-things (IOT) device, and/or toy. The capacitive sensor may include a crossover switch configured to alternatively switch the first and second legs of the first MEMS-based differential accelerometer into the first sensor ring oscillator multiple times during the measurement period. The capacitive sensor may include a register configured to set the threshold value used by the controller. The capacitive sensor may include a memory configured to at least store the threshold value in a non-volatile manner.

In another aspect, a digital accelerometer front end includes a reference oscillator configured to generate a reference frequency signal. The front end also includes a communications interface with a MEM-based differential accelerometer having a first leg and second leg. The communications interface is configured to receive a first frequency signal associated with the first leg and a second frequency signal associated with the second leg from the MEM-based differential accelerometer. The front end includes a crossover switch configured to alternatively switch the output frequency between the first frequency signal and the second frequency signal by alternately reconfiguring a sensing oscillator circuit including the MEMS-based differential accelerometer. The front end further includes a controller configured to receive the reference frequency signal, control a switching period of the crossover switch, receive the first frequency signal and the second frequency signal, convert the first frequency signal into a first counter value, convert the second frequency signal into a second counter value, and compare a difference value between the first and second counter values with a threshold value to detect that sufficient motion has occurred.

The communications interface electrically couples various components (used to configure a resonance frequency of a first ring oscillator) with the MEMS-based differential accelerometer to form the first sensor ring oscillator, where each of the first and second legs of the first MEMS-based differential accelerometer is alternately switched into the first sensor ring oscillator multiple times during a measurement period to reduce the effects of noise.

In some implementations, the controller generates the first counter value corresponding the first frequency signal during a first portion of a measurement period and generates the second counter value corresponding to the second frequency signal during a second portion of the measurement period. The MEMS-based differential accelerometer may be oriented along a first axis. The communications interface may electrically couple components with a second MEMS-based differential accelerometer to form a second ring oscillator. The digital accelerometer front end may be part of a motion sensor for any one of a vehicle alarm, e-Bike alarm, Internet-of-things (IOT) device, and toy.

The controller may be configured to set the reference frequency signal. A register may be configured to set the threshold value. A memory may be configured to at least store the threshold value in a non-volatile manner.

In a further aspect, a process for measuring acceleration of a device using a motion sensor includes: generating, using a first sensor including a first MEMS-based differential accelerometer having a first leg and a second leg, a first frequency signal and a second frequency signal; generating a reference frequency signal via a reference oscillator; receiving the first frequency signal, the second frequency signal, and the reference signal; converting the first frequency signal to a first counter value (Step 608); converting the second frequency signal to a second counter value; calculating a difference value between the first counter signal and the second counter signal; comparing the difference value to a threshold value (614); and determining that sufficient motion has occurred when the difference value is greater than or equal to the threshold value.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows a diagram of a device including a digital front end that interfaces with a MEMS-based sensor according to an implementation of the disclosure.

FIG. 2 shows a circuit diagram of an exemplary motion sensor including an ASIC front end, e.g., a digital front end, and MEMS-based accelerometer, e.g., MEMS-based sensor, according to an implementation of the disclosure.

FIG. 3 shows a more detailed diagram 300 of the ASIC controlled motion sensor of FIG. 2 including a more detailed illustration of the digital block and/or controller according to an implementation of the disclosure.

FIG. 4 shows a diagram of an exemplary ring oscillator switch circuit of, for example, the motion sensor of FIGS. 1-3, according to an implementation of the disclosure.

FIG. 5 shows an exemplary timing diagram associated with circuits of FIGS. 1-4 according to any implementation of the disclosure; and

FIG. 6 includes a process for measuring acceleration of a device using a differential MEMS sensor according to an implementation of the disclsosure.

### DETAILED DESCRIPTION

In the following description, like components have the same reference numerals, regardless of different illustrated implementations. To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

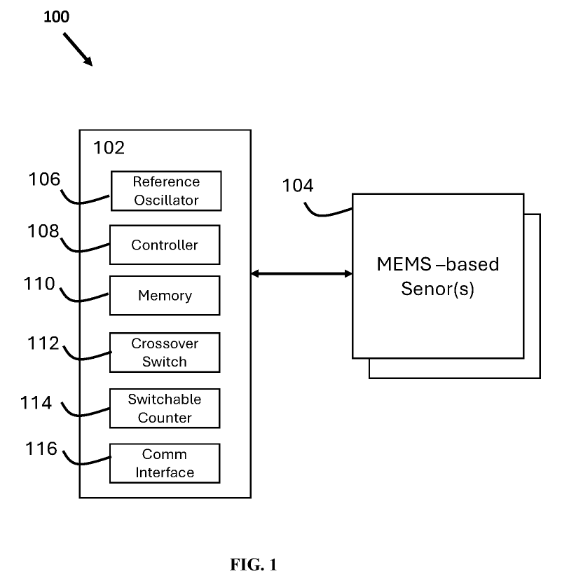

FIG. 1 shows a diagram of a device 100 including a digital front end 102 that interfaces with a MEMS-based sensor 104 according to an implementation of the disclosure. The digital front end may be implemented on an application-specific integrated circuit (ASIC). The digital front end 102 and 104 may be integrated within the same IC or separated on a circuit board or within multiple ICs. The device 100 may be a motion sensor for a vehicle alarm, e-Bike alarm, Internet-of-things (IOT) device, a toy, and the like.

The digital front end 102 may include a reference timer and/or oscillator 106, a controller 108, a memory 110, a crossover switch 112, and a switchable counter 114. The digital front end 102 may interface with one or more MEMS-based sensors. For example, MEM-based sensor 104 may include a MEMS-based differential accelerometer. The reference oscillator 106 may be configured to generate a reference frequency signal. The digital front end 102 may include a communications interface 116 that communicates with a MEM-based differential accelerometer 104 that has a first leg and second leg. The communications interface 116 may be configured to receive a first frequency signal associated with the first leg and a second frequency signal associated with the second leg from the MEM-based differential accelerometer 104.

The crossover switch 114 may be configured to alternatively switch the output frequency between the first frequency signal and the second frequency signal by alternately reconfiguring a sensing oscillator circuit formed by the MEMS-based differential accelerometer 104 along with various components within the digital front end 102.

The controller 108 may be configured to receive the reference frequency signal from reference oscillator 106, control a switching period of the crossover switch 112, receive the first frequency signal and the second frequency signal from MEMS-based differential accelerometer 104, convert the first frequency signal into a first counter value and convert the second frequency signal into a second counter value using switchable counter 114, and compare a difference value between the first and second counter values with a threshold value to detect that sufficient motion has occurred.

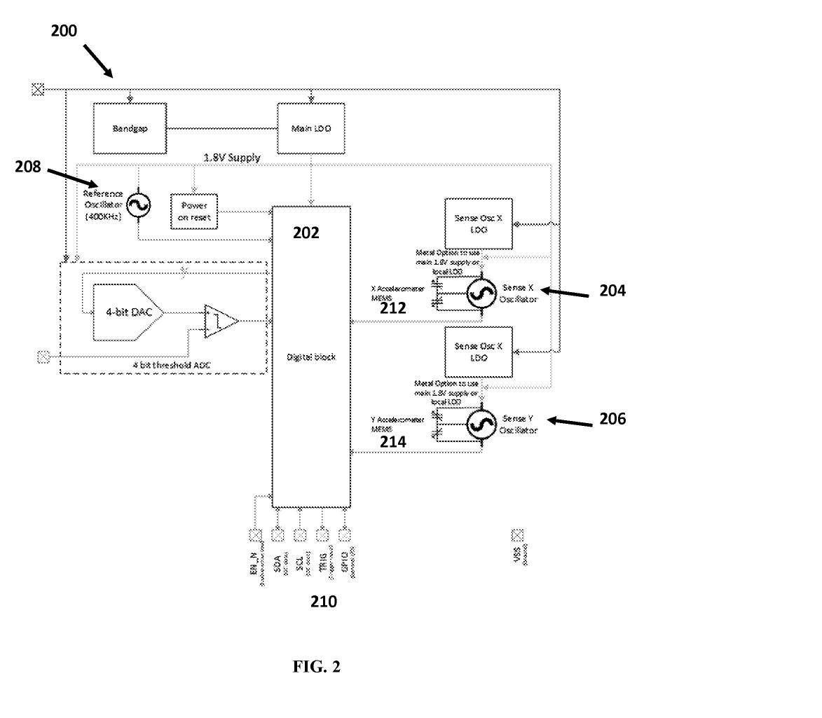

FIG. 2 shows a circuit diagram of an exemplary motion sensor 200 including an ASIC front end, e.g., digital front end 102, and MEMS-based accelerometer, e.g., MEMS-based sensor 104, according to an implementation of the disclosure. Motion sensor 200 may include a sensing oscillator 204 that is formed in part by the first and second legs of a MEMS-based accelerometer 212. Sensing oscillator 204 may be aligned along an X-axis such that it senses motion in an X direction. Sensing oscillator 206 may be formed in part by the first and second legs of a MEMS-based accelerometer 214. Sensing oscillator 206 may be aligned along an Y-axis such that it senses motion in an Y direction. A third sensing oscillator (not shown) may be implemented that is aligned along a Z-axis and senses motion in a Z direction.

Digital block 202 may include a controller, such as controller 108, that performs various functions such as maintaining reference counters, sensor counters, register values, retrieving and sending data to a memory 304, and processing data to perform averaging of counter data and/or to perform motion threshold detection. Digital block and/or controller 202 may receive a reference frequency signal from reference oscillator 208. When controller 202 determines and/or detects that a threshold motion limit has been exceeded, it may output a trigger alert via TRIG pin 210 that may be received, for example, by additional circuitry (not shown) within a device such as device 100 that may trigger a motion alarm or further actions by the device 100.

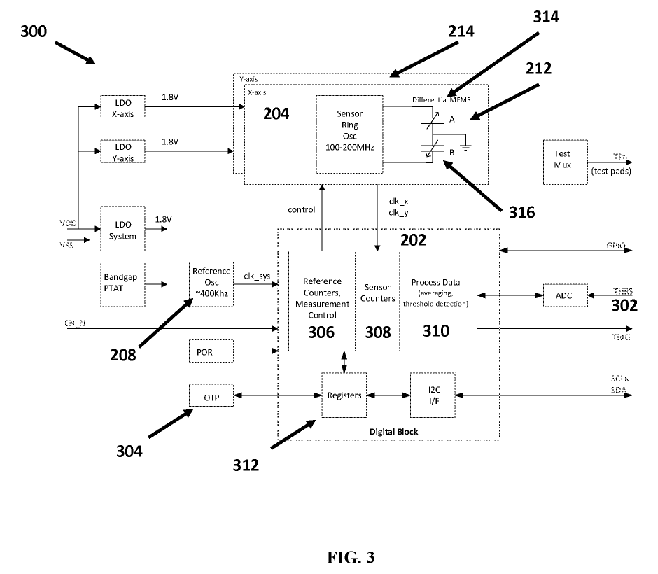

FIG. 3 shows a more detailed diagram 300 of the ASIC controlled motion sensor 200 of FIG. 2 including a more detailed illustration of the digital block and/or controller 202 according to an implementation of the disclosure. Digital block and/or controller 202 may include, for example, reference counters and/or a measurement controller 306, sensors circuits 308, and a processor 310 configured to perform counter averaging and//or threshold limit determination and/or detection. Controller 202 may receive a threshold limit setting via a THRS port 302. The limit value may include a voltage level that may be converted to a digital value by an ADS. The threshold limit may be stored within a memory 304 and/or a register 312. Memory 304 may include a one-time-programmable (OTP) memory to provide non-volatile storage of data.

Diagram 300 shows sensor ring oscillator 204 that is partially formed using MEM-based differential accelerometer 212, which has an A leg 314 and a B leg 316 that are alternative activated by controller 202 via crossover switch 112. Controller 202 receives a reference frequency signal via reference oscillator 208. The reference frequency may be set by controller 202 by configuration data stored in memory 304 or may be fixed by a hardware configuration. The reference frequency may be set at, for example, greater than or equal to one of 1024 kHz, 724 kHz, 512 kHz, 400 kHz, 362 kHz, 256 kHz, 200kHz, 181 kHz, 133 kHz, 100 kHz, 80 kHz, 66.7 kHz, 4 kHz, 2.8 kHz, 2 kHz, 1.4 kHz, and so on.

A MEMS proof mass movement in MEMS-based differential accelerometer 212 may result in a differential change in capacitance between the two legs 314 and 316 of the differential MEMS (also referred to A and B in circuit diagram 300), with a target dC/C/G value. This causes a change in frequency of the sensor ring oscillator 204 which can be detected by controller 202 measuring the number of sensor clock cycles in a fixed measurement period. The measurement period may be set by controller 202 counting clock cycles of reference oscillator 208 with a much lower frequency than the sensor ring oscillators 212 and 214. The captured sensor counter data by controller 202 at the end of a measurement period (also referred to as samples herein) is processed and compared by controller 202 to a threshold level and/or limit that relates to a specific G value. This threshold is set either via the voltage on an external pin (THRS) 302 or via a register setting in, for example, register 312. If the sample data (after processing via routine 310) is equl to or above the threshold setting and/or limit, a trigger alert signal at the TRIG pin 210 is asserted. Therefore, any movement that results in a change in G of a sufficient magnitude that is equal to or above the threshold limit causes the TRIG pin 210 to be asserted.

Each leg 314 and 316 of the MEMS-based differential accelerometer 212 is alternately switched into the sensor ring oscillator circuit multiple times during the measurement period by crossover switch 112 and/or 402 under the control of controller 202, with separate counters 416 and 418 also alternately enabled, providing two samples per measurement period 510, one for the A leg 314 and one for the B leg 316. This scheme is used to reduce the effects of flicker noise. The two counter values are subtracted to provide an equivalent G value for that axis, e.g., the X-axis associated with sensing ring oscillator 204.

There are separate MEMS-based differential accelerometers 212 and 214 and associated ring oscillators 204 and 206, and counters 416 and 418 for two axes, X and Y. The TRIG output signal at pin and/port 210 is asserted if either axis crosses the threshold level. Device 100 may be controlled via an I2C interface that interfaces with motion sensor 200. Memory 304 may include On-chip OTP memory that enables configuring the motion sensor 200 registers, e.g., register 312, that are read on power-up.

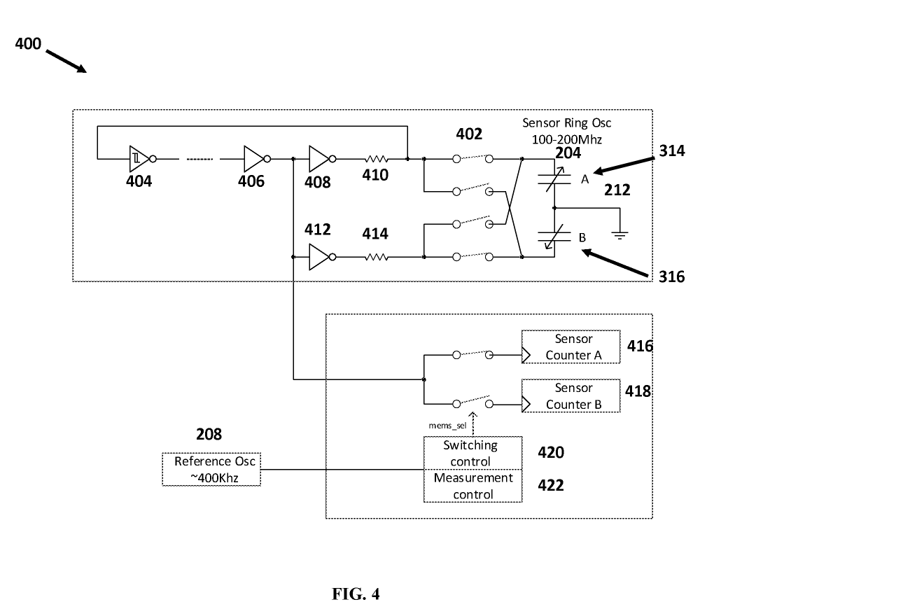

FIG. 4 shows a diagram of an exemplary ring oscillator switch circuit 400 of, for example, motion sensor 200 according to an implementation of the disclosure. MEMS-based differential accelerometer 212 included leg A 314 and leg B 316 represent a differential MEMS device such that the capacitance of leg A 314 increases, and leg B 316 decreases when a positive acceleration is applied. During switch cycle 1, sensor ring oscillator 204 with inverters 404, 406, 408 and resistor 410 and the capacitance of leg A 314 form ring oscillator 204. During switch cycle 1 (switched by crossover switch 402, leg B 316 is driven by a copy circuit by inverter 412 and resistor 414. This minimizes transients when the crossover switch 402 and/or 112 is operated.

During switch cycle 1, sensor ring oscillator 204 pulses are measured in counter A 416 which is a measure of the ring oscillator frequency. During switch cycle 2, the crossover switch 402 is changed so that leg B 316 forms part of the sensor ring oscillator 204 and leg A 314 is driven by the copy circuit. During switch cycle 2, sensor ring oscillator 204 pulses are counted by counter B 418. A reference clock with a lower frequency, e.g., reference oscillator 208, enables controller 202 to control crossover switch 402 to switch between switch cycles 1 and 2 at regular intervals and with an equal mark/space ratio. The values accumulated in counter A 416 and counter B 418 can be combined (e.g., difference or sum) to then represent the frequency of the sensor ring oscillator 204 with the capacitance of MEMS legs A 314 and B 316 respectively. Thus, the acceleration of device 100 can be determined from the counter values in counter A 416 – counter B 418.

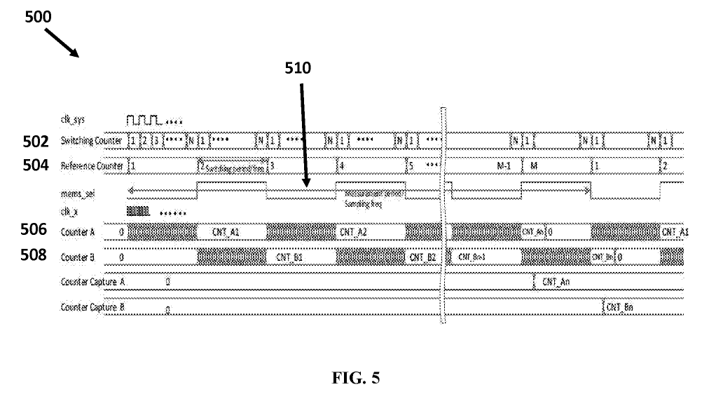

FIG. 5 shows an exemplary timing diagram 500 associated with the motion sensors of FIGS. 1-4 according to any implementation of the disclosure. Timing diagram 500 shows various corresponding timing sequences including a switching counter 502, reference counter 504, counter A 506, and counter B 508, among other counters. Timing diagram 500 illustrates a measurement period 510 where, for example, counter A 420 accumulates a counter value over three switch cycles (e.g., cycle 1 above), while counter B 422 accumulates a counter value over three alternative switch cycles (e.g., cycle 2 above). The counter values accumulated over the measurement period can be used by controller 202 to determine whether motion has been detected as discussed previously herein.

During a measurement period, the sensor ring oscillator 204 clock is used to increment the sensor counters 416 and 418. Each leg of the MEMS 316 and 318 (A and B) is alternately switched into the ring circuit 204 multiple times during measurement period 510. There are two configurations of sensor ring oscillator circuit 204 including configurations A and B.

In configuration A, the top and bottom switches in the switch matrix of the ring oscillator 204 are on, the middle two switches are off. The sensor ring oscillator circuit 204 includes the A leg 314 of the MEMS-based differential accelerometer 212 and leg 314 controls the change of frequency of the ring oscillator 204 due to movement. The B leg 316 of the MEMS-based differential accelerometer 212 is driven by the same frequency as the ring oscillator 204, acting as a load but not affecting the ring oscillator 204 frequency. Sensor counter A 416 is incremented by the ring oscillator 204 clock, sensor counter B 418 is stopped.

In configuration B, the two middle switches in the switch matrix of the ring oscillator 204 are on, while the outer two switches are off. The sensor ring oscillator circuit 204 includes the B leg 316 of the MEMS-based differential accelerometer 212 and leg 316 controls the change of frequency of the ring oscillator due to movement. The A leg 314 of the MEMS-based differential accelerometer 212 is driven by the same frequency as the ring oscillator 204, acting as a load but not affecting the ring oscillator 204 frequency. Sensor counter B 418 is incremented by the ring clock, while sensor counter A 416 is stopped.

At the next repeat of the switching the A and B counters 416 and 418, each counter 416 and 418 starts incrementing from their previously held values. At the end of the measurement period the values on the sensor counters 416 and 418 are captured by controller 202 as illustrated in timing diagram 500 over measurement period 510.

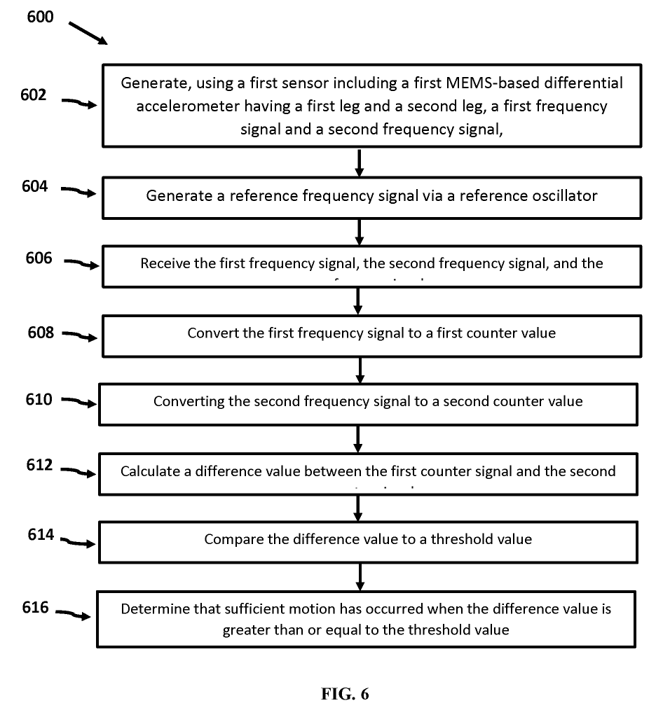

FIG. 6 includes a process 600 for measuring acceleration of a device, e.g., device 100, using a motion sensor such as senor 200 according to an implementation of the disclosure. The process 600 for detecting motion of a device includes: generating, using a first sensor including a first MEMS-based differential accelerometer having a first leg and a second leg, a first frequency signal and a second frequency signal (Step 602); generating a reference frequency signal via a reference oscillator (Step 604); receiving the first frequency signal, the second frequency signal, and the reference signal (Step 606); converting the first frequency signal to a first counter value (Step 608); converting the second frequency signal to a second counter value (610); calculating a difference value between the first counter signal and the second counter signal (612); comparing the difference value to a threshold value (614); and determining that sufficient motion has occurred when the difference value is greater than or equal to the threshold value (616).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

1. A MEMS-based capacitive sensor comprising:
a first sensor including a first MEMS-based differential accelerometer including first and second legs and configured to output a first frequency signal and a second frequency signal,
a reference oscillator configured to output a reference frequency signal; and
a controller arranged to receive the first frequency signal, the second frequency signal, and the reference frequency signal, compare the received frequency signals, and output a trigger signal when a threshold value is exceeded.

2. The capacitive sensor of claim 1, wherein a MEMS capacitance of the first MEMS-based differential accelerometer is 50fF or less.

3. The capacitive sensor of claim 1, wherein the first MEMS-based differential accelerometer includes a first sensor ring oscillator and wherein each of the first and second legs of the first MEMS-based differential accelerometer is alternately switched into the first sensor ring oscillator multiple times during a measurement period to reduce the effects of noise.

4. The capacitive sensor of claim 1, wherein the controller includes a first sensor counter configured to generate a first counter value corresponding the first frequency signal and a second sensor counter configured to generate a second counter value corresponding to the second frequency signal over the measurement period.

5. The capacitive sensor of claim 1, wherein the first sensor is oriented along a first axis.

6. The capacitive sensor of claim 1 comprising a second sensor including a second MEMS-based differential accelerometer including third and fourth legs configured to output a third frequency signal and a fourth frequency signal, wherein the second MEMS-based differential accelerometer includes a second sensor ring oscillator circuit and wherein each of the third and fourth legs of the second MEMS-based differential accelerometer are alternately switched into the second sensor ring oscillator circuit multiple times during the measurement period to reduce the effects of noise.

7. The capacitive sensor of claim 1, wherein the capacitive sensor functions as a motion sensor for any one of a vehicle alarm, e-Bike alarm, Internet-of-things (IOT) device, and toy.

8. The capacitive sensor of claim 1 comprising a crossover switch configured to alternatively switch the first and second legs of the first MEMS-based differential accelerometer into the first sensor ring oscillator multiple times during the measurement period.

9. The capacitive sensor of claim 1 comprising a register configured to set the threshold value used by the controller.

10. The capacitive sensor of claim 1, comprising a memory configured to at least store the threshold value in a non-volatile manner.

11. A digital accelerometer front end comprising:
a reference oscillator configured to generate a reference frequency signal;
a communications interface with a MEM-based differential accelerometer having a first leg and second leg, the communications interface configured to receive a first frequency signal associated with the first leg and a second frequency signal associated with the second leg from the MEM-based differential accelerometer;
a crossover switch configured to alternatively switch the output frequency between the first frequency signal and the second frequency signal by alternately reconfiguring a sensing oscillator circuit including the MEMS-based differential accelerometer;
a controller configured to receive the reference frequency signal, control a switching period of the crossover switch, receive the first frequency signal and the second frequency signal, convert the first frequency signal into a first counter value, convert the second frequency signal into a second counter value, and compare a difference value between the first and second counter values with a threshold value to detect that sufficient motion has occurred.

12. The digital accelerometer front end of claim 11, wherein the communications interface electrically couples components with the MEMS-based differential accelerometer to form a first sensor ring oscillator and wherein each of the first and second legs of the first MEMS-based differential accelerometer is alternately switched into the first sensor ring oscillator multiple times during a measurement period to reduce the effects of noise.

13. The digital accelerometer front end of claim 11, wherein the controller generates the first counter value corresponding the first frequency signal during a first portion of a measurement period and generates the second counter value corresponding to the second frequency signal during a second portion of the measurement period.

14. The digital accelerometer front end of claim 11, wherein the MEMS-based differential accelerometer is oriented along a first axis.

15. The digital accelerometer front end of claim 11, wherein the communications interface electrically couples components with a second MEMS-based differential accelerometer to form a second ring oscillator.

16. The digital accelerometer front end of claim 11, wherein the digital accelerometer front end is part of a motion sensor for any one of a vehicle alarm, e-Bike alarm, Internet-of-things (IOT) device, and toy.

17. The digital accelerometer front end of claim 11, wherein the controller is configured to set the reference frequency signal.

18. The digital accelerometer front end of claim 11, comprising a register configured to set the threshold value.

19. The digital accelerometer front end of claim 11, comprising a memory configured to at least store the threshold value in a non-volatile manner.

20. A method for detecting motion of a device comprising:
generating, using a first sensor including a first MEMS-based differential accelerometer having a first leg and a second leg, a first frequency signal and a second frequency signal;
generating a reference frequency signal via a reference oscillator;
receiving the first frequency signal, the second frequency signal, and the reference signal;
converting the first frequency signal to a first counter value;
converting the second frequency signal to a second counter value;
calculating a difference value between the first counter signal and the second counter signal;
comparing the difference value to a threshold value; and
determining that sufficient motion has occurred when the difference value is greater than or equal to the threshold value.
